(19) United States
(12) Patent Application Publication
(10) Pub. No.: US 2025/0233646 A1
(43) Pub. Date: Jul. 17, 2025

(54) NETWORK-CONTROLLED REPEATER DEVICES AND ASSOCIATED CONTROL SIGNALLING

(71) Applicant: Sony Group Corporation, Tokyo (JP)

(72) Inventor: Rickard LJUNG, Helsingborg (SE)

(21) Appl. No.: 18/702,723

(22) PCT Filed: Nov. 15, 2022
(86) PCT No.: PCT/EP2022/082011

§ 371 Date: Apr. 18, 2024

(30) Foreign Application Priority Data
Nov. 16, 2021 (SE) 2151396-5

(51) Int. Cl. H04B 7/155; H04L 5/00

(52) U.S. Cl. CPC H04B 7/15528; H04L 5/0048

(57) ABSTRACT

Various aspects of the disclosure generally relate to interoperability between a network and a network configured repeater device. Various aspects of the disclosure generally relate to respective control signaling. Some examples relate to network-configured repeater devices providing a control link to one or more wireless communication devices.

### TECHNICAL FIELD

Various examples of the disclosure generally relate to repeater devices that are remote controlled. Various examples of the disclosure specifically relate to associated control signaling.

### BACKGROUND

To enhance the coverage of a wireless transmission, repeater devices (RDs) can be employed. RDs can implement an “amplify-and-forward” functionality. RDs can apply spatial filters to tailor an outgoing beam. Thereby, non-line-of-sight communication is facilitated.

US2021037459 AA discloses aspects with respect to RDs.

RDs can also be employed in cellular networks (NWs) such as those defined by the Third Generation Partnership Project (3GPP). RDs can enhance the coverage of a base station of the cellular NW, so that wireless communication devices (UEs) can be better served. For instance, there has been a proposal to add so-called “smart repeaters”, see 3GPP RWS-210019 (title: “NR Smart Repeaters”). Here, it is described that a base station (BS) of the cellular NW can provide a configuration to an RD, e.g., to switch the RD on or off, provide timing information of a time-division duplex allocation to enable the RD to have awareness of which timeslots are being used for uplink transmission and which timeslots are used for downlink transmission, or to provide spatial transmit/receive information to thereby define the beams of the receiver. Thus, such smart repeaters that are controlled by the NW are sometimes also referred to as NW-controlled RDs.

### SUMMARY

There is a need for advanced techniques of configuring NW-controlled RDs.

According to examples, control data is transmitted by a BS that serves a cell of a cellular NW. The control data pertains to a control link that is provided by one or more NW-configured RDs in the cell. The one or more NW-configured RDs provide a repeater-mediated connectivity to UEs in the cell. The control link supports the repeater-mediated connectivity.

Since the control link is provided by the one or more NW-configured RDs to UEs, it may be labeled as a forward-facing control link (FF control link); as opposed to a control link established between the BS and the one or more RDs which control link may be labeled as a backbone control link.

By providing the control data of the FF control link, the FF control link can be advertised to UEs in the cell. By such techniques, UEs in the cell are facilitated to monitor the control link.

By providing the control data, variable configurations of the FF control link are facilitated. For instance, cell-specific configurations would be possible. For instance, RD-specific configurations would be possible. The configuration can be changed dynamically, e.g., depending on a coverage situation in the cell. For instance, mobile RDs may exhibit mobility and, along with the mobility of the RDs, the configuration of the control link may be changed. By providing the control data that is associated with the configuration of the control link, even in view of such variable configurations of the FF control link, UEs can monitor the FF control link.

For instance, the control data can be indicative of resources allocated to the control link. Time-frequency resources could be indicated. The time-frequency resources could be defined with respect to a time-frequency resource grid of a carrier of the cell. The resources could pertain to a modulation format of the control link.

The control data could be indicative of resources that are allocated to a least one of repeater reference signals (RRSs) or detection beacons that are transmitted by the one or more NW-configured RDs on the FF control link.

The RRSs can help to sound a channel between the RD and the respective UE.

The detection beacons can facilitate detecting RDs by UEs in the surrounding. An identity of the RDs can be revealed to the UEs.

The control data could be indicative of a type or a configuration of RRSs that are transmitted by the one or more NW-configured RDs of the control link.

For instance, there may be different candidate types of RRSs and by means of the control data can be indicated which of those RRSs are currently activated. Example types would be synchronization RRSs or demodulation RRSs.

On-demand transmission of RRSs becomes possible.

The control data can include information associated with an identity of each one of the one or more NW-configured RDs. Such identity may be used by the respective one of the one or more NW-configured RDs for communicating on the control link.

By means of such identity, unique identification of the NW-configured RDs by the UEs becomes possible.

The control data can, accordingly, correspond to a configuration of the FF control link or, more generally, to a configuration of the NW-configured RD. For example, the control data could include certain parts of the configuration of relevance to the UE.

Such control data can be generally transmitted upon a request by a UE for the control data.

The UE could request the control data while operating in an idle mode or, more generally, while not being connected to the cellular NW. It would also be possible that the UE requests the control data while operating in a connected mode.

Further, the UE could request the control data while not being served via the RD or in a state where it is transparent whether the UE is being served via the RD. Where the UE requests the control data while not being served via the RD or while it is transparent whether the UE is being served via the RD, this can serve the purpose of determining whether coverage can be enhanced by enabling serving of the UE via the RD. Another purpose would be to determine whether the UE is actually being served via the RD, by implementing respective channel measurements based on RRSs.

For instance, such request could be associated with an information element that is indicative of the one or more NW-configured RDs being present in the cell. Such information element can be transmitted by the BS, e.g., in a broadcast message such as a system information block. By such techniques, a pre-notification of a NW-configured RD being present in the cell can be provided and, if required, the UE could request the control data.

The control data could, in some scenarios, also be proactively transmitted by the BS. For instance, the BS may repeatedly transmit the control data. For instance, predefined transmission resources may be allocated to the transmitting of the control data.

According to various examples, it would be possible that the control data is transmitted in response to a coverage scenario of the UE or the one or more NW-configured RDs fulfilling a predefined criterion. Thus, it would be possible that only under certain circumstances the control data is transmitted. This enables provisioning of the control data, e.g., in cell-edge scenarios where repeater-mediated connectivity is potentially beneficial.

As a general rule, scheduling of transmissions on the control link can be implemented at the RD or at the BS. For instance, in an out-of-band deployment of the control link—i.e., the control link uses frequencies that do not overlap with the carrier or carriers of the BS—scheduling may be implemented at the RD. Even where the scheduling is implemented at the RD, there may be time and frequency synchronization between the RD and the BS.

In scenarios where the scheduling of the transmission on the control link is implemented at the BS, the BS can synchronize scheduling of a first transmission of data communicated between the BS and the UE and of a second transmission on the control link. This mitigates collisions between BS-UE transmissions and transmissions on the control link.

Such synchronization may include defining time gaps during which the first transmission is paused. By means of the time gaps, monitoring of the control link by the UE is facilitated during the time gaps. This would correspond to a time division duplex scheme.

The BS can also schedule a shared control link that is accessed by multiple RDs. For instance, transmissions of multiple RDs can be co-scheduled on the control link.

The BS can provide a configuration to the one or more NW-configured RDs to provide the control link in accordance with the control data.

Above, scenarios have been disclosed in which the control data is transmitted to the UE or UEs. It is not required in all scenarios that the control data of the control link is transmitted to UEs. For instance, in some scenarios the configuration may be fixedly defined and, accordingly, the control data may also be predefined and known to the wireless communications devices.

According to various examples of the disclosure, a BS of a cell of a cellular NW can receive, from a UE in the cell, a report message that is indicative of a device-specific repeater information of at least one NW-configured RD of one or more NW-configured RDs in the cell. Thereby, providing a configuration to the at least one NW-configured RD is facilitated.

Thus, UE-specific reporting regarding repeater information, as seen from the respective UE, is facilitated. Such UE-specific reporting can generally enhance the available information depth of the BS used to determine a configuration of a respective RD.

Such reporting can be received while the UE is not being served via a NW-controlled RD or while it is being served via an NW-controlled RD. The reporting could be received while it is transparent whether the UE is being served via an NW-controlled RD.

Accordingly, there can be multiple use cases for device-specific repeater information. In a first use case, a UE can provide device-specific repeater information while not being served via the NW-controlled RD. Then, based on such reporting, it could be judged whether, based on the current configuration, the UE could benefit from being served via the NW-controlled RD; or whether the configuration of the NW-controlled RD can be adjusted so that for the reporting UE it becomes attractive to be served via the RD. For instance, a spatial filter of the NW-controlled RD could be adjusted so that the coverage situation at the UE is enhanced. For instance, the position of the RD could be adjusted so that the coverage situation at the UE is enhanced. In view of this new configuration, serving the UE via the NW-controlled RD may improve the coverage situation. In a second use case, the UE can provide the device-specific repeater information and the BS can use this information to adjust the RD configuration—however, with the purpose of enhancing the coverage situation for other UEs in the vicinity of the reporting UE. In a third use case, a UE that is already being served via the RD can report and, based on this reporting, the configuration of the RD can be adjusted to further enhance the coverage situation at the UE.

In any such scenario, the BS can provide a configuration to the RD based on the device-specific repeater information.

According to examples, the configuration can include switching off the NW-configured repeater device. For instance, it is possible to judge that there is currently no UE that is being served via the NW-configured repeater device and, accordingly, to preserve power, the NW-configured repeater device may be switched off.

It would be possible to adjust a transmit power of the NW-configured RD. For instance, the transmit power may be reduced if the channel between the NW-configured RD and the UE is excessively strong.

It would be possible to adjust one or more spatial filters at the NW-configured RD. For instance, an output beam may be aligned with the position of the UE.

The location of the NW-configured RD may be adjusted. For instance, mobile RD can be repositioned to better serve a UE.

According to examples, the configuration can include activating or deactivating or, more generally, configuring a transmission of at least one type of repeater reference signals. For instance, demodulation repeater reference signals may be activated or deactivated or, more generally, configured.

A reconfiguration message can be transmitted to the UE upon providing such (re-)configuration to the NW-configured RD.

Various options are available regarding the information content of the device-specific repeater information. Examples include a measurement report of a general measurement that is performed by the UE, e.g., based on repeater reference signals. It would also be possible that the device-specific repeater information is indicative of whether the UE is being served via the NW-configured RD. The device-specific repeater information could be indicative of an identity of any discovered NW-configured RD.

There can be scenarios in which NW-controlled RDs are only sparsely deployed. I.e., scenarios are conceivable where only some of the cells of a cellular NW include an activated NW-controlled RD. Further, scenarios are possible in which the configuration of NW-controlled RDs is comparably static, i.e., does not change frequently.

In such and other scenarios, it can be a desire to provide a pre-indication to UEs in a cell regarding presence or absence of NW-controlled RDs.

Depending on the structure or configuration of the FF control link, scenarios can occur according to which not all UEs in a cell of the cellular NW have the capability of monitoring the FF control link. For instance, depending on the radio technology used for the control link, some UEs may not have the capability of monitoring the FF control link. For instance, some UEs may not have the software-capability of monitoring the FF control link.

According to various examples of the disclosure, a BS of a cell of the cellular NW can receive, from a UE, a capability information element. The capability information element can be indicative of a capability of the UE to support communication between one or more NW-configured RDs and the UE on an FF control link.

A broadcast transmission is possible.

According to various examples of the disclosure, it is possible that a BS of a cell of a cellular NW transmits, to one or more wireless communications devices in the cell, a message that includes an information element that is indicative of the presence of one or more NW-configured RDs in the cell.

A broadcast transmission is possible.

Thereby, it is possible to alert UEs in the coverage area of the BS that NW-controlled RDs are available to support transmission between the BS and the UEs using repeater-mediated connectivity. For instance, these UEs could then react appropriately, e.g., check whether they are aware of control data of an FF control link. The UEs may then request control data. The UEs may then indicate a capability to support monitoring of the FF control link on demand.

It would also be possible that the BS selectively transmits the message that includes the information element that is indicative of a presence of the one or more NW-configured RDs if there is a UE that has the capability to monitor the FF control link.

According to various examples, a UE that is connectable to a cellular NW receives control data of a control link that is provided by one or more NW-configured RDs in a cell of the cellular NW.

Based on the control data, the UE can monitor the control link. Based on said monitoring of the control link, the UE can determine, for a least one NW-configured RD of the one or more NW-configured RDs, device-specific repeater information.

The UE may transmit, to the BS, a report message that includes the device-specific repeater information.

As a general rule, monitoring may pertain to attempting to receive on the control link. Sometimes, the UE may be out of range and thus may attempt to receive, but actually not receive.

Depending on the control signaling implemented on the FF control link, different types of signals or messages may be received by the UE.

For instance, the UE may detect at least one NW-configured RD based on said monitoring of the control link. The device-specific repeater information can then be indicative of an identity of the at least one NW-configured RD.

For instance, the detecting can include monitoring for a detection beacon that is repeatedly transmitted by the at least one NW-configured RD on the control link.

By reporting on the identity of the at least one NW-configured RD that is detected by the UE, the BS is facilitated to establish a coverage map determining which UEs are seeing which RDs.

Based on said monitoring of the control link, the UE may measure a channel quality based on RRSs that are repeatedly transmitted by the at least one RD only control link. Then, the device-specific repeater information can be indicative of the channel quality.

Thereby, it is possible to sound a leg of the overall transmission path between the BS and the UE that is between the RD and the UE.

Based on said monitoring of the control link, it would be possible to determine, by the UE, whether the UE is being served via the RD. The device-specific repeater information can be indicative of whether the UE is served via the at least one RD.

According to various examples, the repeater-mediated connectivity may be implemented transparently to the UE. This means that a transmission between the UE and the BS may not be indicative of the transmission path going through an RD or not. The BS may not be aware of whether the UE is being served via the RD or not.

By using the control link, it may be possible to reveal whether the UE is being served via the RD or not. For instance, it would be possible to measure a first channel characteristic based on RRSs that are repeatedly transmitted by the at least one NW-controlled RD on the control link, based on said monitoring of the control link. Such RRSs may be known to originate from the RD. Additionally, it is possible to measure a second channel characteristic based on base-station reference signals repeatedly transmitted by the BS. The BS reference signals may be known to originate from the BS. Then, it is possible to implement a comparison of the first channel quality and the second channel quality to thereby determine whether the UE is served via the at least one NW-controlled RD. specifically, where the channel characteristic derived from the RRSs is worse than the channel characteristic derived from the BS reference signals, this is an indication of the UE not being served via the NW-controlled RD.

Such channel characteristics can include at least one of a respective spatial filter, a respective signal strength, or a respective channel fading variation. these are examples of characteristics that can be compared by the UE to judge whether there are significant differences between the channel along which the RRSs are received and the channel along which the BS reference signals are received.

The UE may monitor the FF control link during time gaps notified by the BS, e.g., in the control data. During the time gaps, the UE may not need to expect data transmission from the BS or scheduling grants for UL data transmission to the BS. This can give the UE an opportunity to change radio-frequency receiver properties, e.g., tune the frequency to the frequency of the FF control link, etc., so that collisions are avoided.

According to various examples of the disclosure, a UE connectable to a cellular NW receives, from a BS of a cell of the cellular NW, a message. The message includes an information element that is indicative of the presence of one or more NW-configured RDs in the cell. The one or more NW-configured RDs provide a repeater-mediated connectivity to the UE in the cell. The message may be received while the UE operates in the idle mode. The message may be broadcasted.

Based on an information element that is indicative of the presence of the one or more NW-configured RDs, the UE may transmit to the BS a request for control data of a control link that is provided by the one or more NW-configured RDs and the cell of the cellular NW.

For instance, the request for the control data may be selectively transmitted depending on at least one trigger criterion. For instance, the at least one trigger criterion may include a channel quality measured by the UE based on reference signals that are transmitted, e.g., by the BS. Another example trigger criterion is a mobility level of the UE.

According to various examples of the disclosure, a NW-configured RD in a cell of a cellular NW that is served by a BS of the cellular NW obtains, from the BS, a configuration to provide a control link. The NW-configured RD can then provide, in accordance with the configuration, the control link to one or more UEs in the cell, to thereby support a repeater-mediated connectivity between the one or more UEs in the BS.

It is to be understood that the features mentioned above and those yet to be explained below may be used not only in the respective combinations indicated, but also in other combinations or in isolation without departing from the scope of the disclosure.

### BRIEF DESCRIPTION OF THE DRAWINGS

FIG. 1 schematically illustrates a communication system including a BS of a cellular NW, a UE, and a NW-controlled RD according to various examples.

FIG. 2 schematically illustrates a method according to various examples.

FIG. 3 schematically illustrates a device according to various examples.

FIG. 4 is a flowchart of a method according to various examples.

FIG. 5 is a flowchart of a method according to various examples.

FIG. 6 is a flowchart of a method according to various examples.

FIG. 7 is a signaling diagram of communication between the UE and the BS according to various examples.

FIG. 8 is a signaling diagram of communication between the UE, the BS, and the RD, according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the disclosure will be described in detail with reference to the accompanying drawings. It is to be understood that the following description of embodiments is not to be taken in a limiting sense. The scope of the disclosure is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques of a wireless communication between multiple devices or nodes are disclosed. Techniques will be described with respect to communication between a BS of a cellular NW and UEs. Wireless communication is facilitated by one or more RDs.

As a general rule, an RD as described herein can provide an amplify-and-forward functionality. A translation to the baseband of received signals may or may not be implemented. The RDs may operate on Layer 1, Layer 2, or Layer 3. The RDs could also be implemented by reflective surfaces; here, an amplification is not provided for; rather, a variable phase shift is applied by individual antenna elements of the reflective surfaces. This facilitates applying certain spatial filters. For instance, a well-defined output may be defined into which incident electromagnetic waves are reflected.

The repeater-mediated connectivity may be transparent to the UE. This means that, based on a transmission between the UE and the BS, the UE may not be able to judge whether the transmission is facilitated by the RD or not.

According to various examples, a configuration of the RD can be provided by a BS. Accordingly, there can be a control link implemented between the BS and the RD.

Such control link can be referred to as backbone control link. The RDs can be labelled “NW-controlled RDs”.

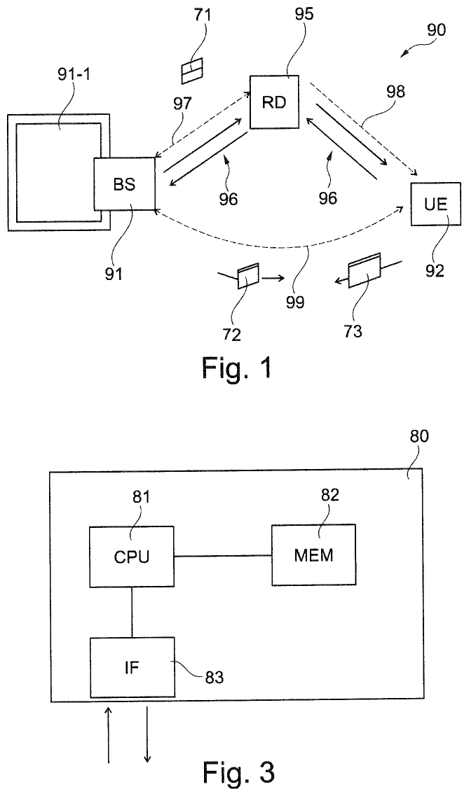

FIG. 1 schematically illustrates a communication system 90 according to various examples. The communication system 90 includes a BS 91 of a cellular NW 91-1. A backbone control link 97 is established between the BS 91 and an NW-controlled RD 95.

A data transmission 96 between the BS 91 and the UE 92 is facilitated by the RD 95. Illustrated in FIG. 1 is also an FF control link 98 provided by the RD 95 to the UE 92. Using the FF control link 98, the RD 95 can provide information to the UE 92 or enable the UE 92 to gather information by monitoring the FF control link 98.

The FF control link 98, as a general rule, may be an in-band FF control link, i.e., may reside within the frequency band width of the carrier of the cell provided by the BS 91. This means, that the transmission 96 between the BS 91 and the UE 92 and a transmission on the control link 98 use overlapping frequencies. The FF control link 98 may also be an out-of-band FF control link, i.e., distinct frequencies may be used for the transmission on the control link 98 and the transmission 96.

There is also illustrated a control link 99 between the BS 91 and the UE 92. This is a logical control link that can be implemented using the data transmission 96. For instance, this control link 99 could be implemented using Radio Resource Control (RRC) control signaling on a Physical Uplink Shared Channel (PUSCH) and a Physical Downlink Shared Channel (PDSCH). The control link 99 could be alternatively or additionally implemented on a Physical Uplink Control Channel (PUCCH) and a Physical Downlink Control Channel (PDCCH).

The BS 91 can provide a configuration 71 to the RD 95 via the control link 97. Various operational parameters of the RD 95 can be set using the configuration 71. Example operational parameters are listed below in TAB. 1.

| Operational | |
|---|---|
| Parameter | Description |
| On/off | The BS 91 can switch on or can switch off the RD 95. |
| switching | |
| Transmit | A repeater gain can be set. For instance, the transmit |
| power | power for an active repeater can be set. |
| Spatial filter | The BS 91 can activate a certain spatial filter at the RD |
| | 95. The spatial filter can define one or more input |
| | directions from which electromagnetic |
| | waves are accepted. |
| | The spatial filter can define one or more output directions |
| | into which electromagnetic waves are transmitted. A |
| | codebook could be used for activating certain spatial |
| | filters. |
| Location | Some RDs may be mobile. The RD may be integrated |
| | into a drone or some other mobile object. It would be |
| | possible to set a location of the RD. |
| FF control | The FF control link 98-facilitating control signaling from |
| link | the RD to UEs in its vicinity-can be configured by the |
| | BS. |

TAB. 1: various examples for operational parameters of a RD that can be set by a BS by providing a respective configuration 71 to the NW-controlled RD. The configuration can be provided by control data that is communicated on the backbone control link 97 from the BS to the RD.

Next, details with respect to providing a configuration 71 of the FF control link 98 will be explained in connection with TAB. 2 (cf. TAB. 1, last row). This configuration 71 of the FF control link 98 is, generally, part of the general configuration of the NW-controlled RD.

| Operational | |
|---|---|
| parameter | |
| of FF | |
| control link | Description |
| RRSs | The BS can activate or deactivate or, generally, configure |
| | transmission of at least one type of RRS on the FF con- |
| | trol link 98. For instance, it would be possible to set a |
| | frequency hopping pattern of the at least one type of RRS, |
| | set a frequency range in which the RRSs are transmitted, |
| | set a timing pattern with which the RRSs are transmitted, |
| | or set a spatial filter for the transmission of the at least |
| | one type of RRS. for instance, there may be various types |
| | of RRSs and different types may be configured differently. |
| | For instance, there could be demodulation RRSs. It would |
| | be possible that the configuration defines resources that |
| | are allocated to the RRSs. |
| Detection | the BS can activate or deactivate or, generally, configure |
| beacons | transmission of detection beacons on the FF control link |
| | 98. For instance, it would be possible to set a frequency |
| | hopping pattern of the detection beacons, set a frequency |
| | range in which the detection beacons are transmitted, set |
| | a timing pattern with which the detection beacons are |
| | transmitted, or set a spatial filter for the transmission of |
| | the detection beacons. It would be possible that the con- |
| | figuration defines resources that are allocated to the de- |
| | tection beacons. The detection beacons can facilitate de- |
| | tection of an RD by UEs. Based on the detection bea- |
| | cons, UEs may uniquely identify an RD. |
| Setting a | For instance, it would be possible that transmission on |
| timing of a | the FF control link 98 is restricted to certain time dura- |
| trans- | tions. Such time durations can equate to scheduling gaps |
| mission | during which the transmission 96 is not scheduled. Thus, |
| on the FF | the transmission on the FF control link 98 and the trans- |
| control link | mission 96 between the BS 91 and the UE 92 can be syn- |
| 98 | chronized. Time gaps during which the transmission 96 is |
| | paused can be defined, to thereby facilitate monitoring of |
| | the FF control link 98 by the UE 92 during these time |
| | gaps. |
| | More generally, the BS 91 may schedule transmissions |
| | on the FF control link 98. This can be, in particular, help- |
| | ful where multiple NW-configured RDs share the FF con- |
| | trol link 98. The BS 91 can then co-schedule transmis- |
| | sions of the multiple NW-configured RDs on the FF con- |
| | trol link 98. |
| Resources | Time-frequency resources can be allocated to the FF |
| | control link 98. These time-frequency resources can be |
| | defined in a timing and frequency reference of the BS 91. |
| | For instance, the time-frequency resource could be de- |
| | fined in a time-frequency resource grid of a modulation |
| | scheme used by the BS 91 for the transmission 96. |
| | Thus, the resources could be time-frequency resources of |
| | a time-frequency resource grid of a carrier. |
| | It would be possible to indicate a modulation format to be |
| | used by the FF control link. For instance, it could be indi- |
| | cated whether the binary phase shift keying, quadrature |
| | phase shift keying, or another modulation form it is to be |
| | used. |

TAB. 2: Operational parameters of the FF control link. While above a scenario has been described in which such operational parameters of the FF control link 98 are set by the BS 91, as a general rule, it would also be possible that such operational parameters are, at least to some extent, predefined where set at the RD. Then, it would be possible that the RD, via the backbone control link 97 informs the BS accordingly.

As will be appreciated, there is a wide variety of possible configurations of the FF control link. Accordingly, it is possible that the BS 91 transmits, to the UE 92, control data of the FF control link 98 that is provided by the RD 95. Thereby, the control link can be advertised to the UE 92 (and potentially further UEs).

The control data 72 can be indicative of one or more operational parameters as discussed above in connection with TAB. 2, e.g., the control data could be indicative of resources allocated to the FF control link 98. The resources could be at least one of time-frequency resources of a time-frequency resource grid of a carrier of the cell provided by the BS 91 or a modulation format of the FF control link 98. The control data 72 could be indicative of resources that are allocated to RRSs or detection beacons that are transmitted by the RD 95 on the FF control link 98. It would be possible that the control data 72 is indicative of a type or configuration of RRSs that are transmitted by the RD 95 on the control link 98. The control data 72 could include information that is associated with an identity of the RD 95. The identity could be used by the RD 95 when communicating on the control link 98. For instance, it would be possible to scramble information using a code that is associated with the identity. It would be possible that resources are uniquely allocated depending on the identity. It would be possible that the beacon signals are indicative of the identity.

Upon receiving the control data 72 of the FF control link 98 and based on the control data 72 of the FF control link 98, the UE 92 can then monitor the FF control link 98. For instance, information regarding the channel between the RD 95 and the UE 92 could be determined. It could be determined whether the UE 92 is in-coverage of the RD 95. Interference could be detected.

Based on such monitoring, it would then be possible that the UE 92 transmits a report message 73 that is indicative of UE-specific repeater information of the RD 95 to the BS 91 on the control link 99. Then, based on such UE-specific repeater information included in the report message 73, the BS 91 may determine a new or adjusted configuration of the RD 95 and, again, provide a respective configuration 71 to the RD 95.

The report message 73 could be an RRC control message transmitted on PUSCH.

As a general rule, the content of the report message 73 may vary for various scenarios disclosed herein. Specifically, the content of the report message 73 may vary for different configurations of the control link 98, e.g., depending on whether the RRSs would be transmitted and/or where the beacon signals would be transmitted, etc.

A few examples of a possible content of the report message 73 are provided below in TAB. 3. TAB. 3 describes options for the device-specific repeater information.

| | |
|---|---|
| Measurement | For instance, the UE-specific repeater information may |
| report | include a measurement report of a channel measurement |
| | that is performed by the UE based on RRSs that are |
| | transmitted by the RD 95. For instance, a signal strength, |
| | receive phase, angle of reception, etc. may be indicated. |
| UE being | It would be possible that the UE-specific repeater infor- |
| served via | mation indicates whether the UE is being served via the |
| RD | RD 95. For instance, it would be possible that the UE |
| | compares a receive property of RRSs that are transmitted |
| | by the RD 95 with BS reference signals that are transmit- |
| | ted by the BS. Based on such comparison, the UE 92 |
| | may then conclude on whether it is being served via the |
| | RD 95 or not. |
| RD identity | The UE-specific repeater information could be indicative |
| | of an identity of the RD 95. Thereby, the UE could indi- |
| | cate which specific RDs are within coverage. Such infor- |
| | mation indicative of the identity could be derived from |
| | detection beacons that are transmitted by the RD. |

TAB. 3: Various examples of UE-specific repeater information that can be transmitted by the UE 92 to the BS 91 using a report message 73.

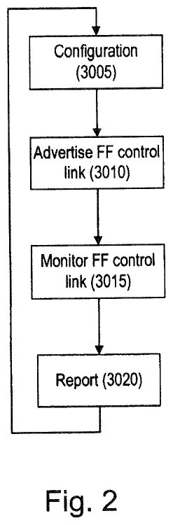

FIG. 2 is a flowchart of a method according to various examples. The method of FIG. 2 illustrates the overall sequence of phases of interoperability of the BS 91, the RD 95, and the UE 92, the interoperability pertaining to configuring the RD 95, informing the UE 92 of the FF control link 98, etc.

At box 3005, the BS 91 provides the configuration 71 to the RD 95. The RD 95 then commences operation in accordance with this configuration 71. Specifically, at box 3005, the BS 91 may activate the FF control link 98. Examples have been described in connection with TAB. 1 and TAB. 2.

Then, at box 3010, the BS 91 can advertise the FF control link 98. This can be implemented by providing respective control data 72 to UEs in the cell. For instance, the control data could be broadcasted or transmitted in a unicast or a multicast message.

Then, the UEs in the cell, such as the UE 92 (cf. FIG. 1) can monitor the FF control link 98 based on the control data, at box 3015. Based on said monitoring of the control link, the respective UE can determine the UE-specific repeater information and transmit the respective report message 73, at box 3020. This has been described in TAB. 3.

Then, box 3005 can be executed anew, taking into account the UE-specific repeater information.

This illustrates how based on the UE involvement the configuration of the NW-controlled RDs can be refined and tailored to the particular coverage scenario. Various techniques are based on the finding that accurate configuration of RDs can be facilitated by enabling communication from an RD to UEs in its vicinity. Specifically, additional decision basis can be added to BS-controlled configuration of RDs. According to various examples, aspects with respect to low-complexity and low-overhead control signaling between the BS, the RDs and UEs are disclosed to facilitate such exchange of information that enables accurate configuration of the RD. According to the various aspects disclosed herein, the control signaling can account for changes in the system state of the respective communication system, e.g., due to mobility of the UEs or generally variations of the radio signal quality.

FIG. 3 schematically illustrates a communication node according to various examples. The communication node 80 can implement any one of the BS 91, the UE 92, or the RD 95.

The communication node 80 includes a processor 81 and the memory 82 and a wireless communication interface 83. The processor 81 can load and execute program code from the memory 82. Upon loading and executing the program code, the processor 81 can perform techniques as disclosed herein, e.g., in connection with configuring or operating a front-facing controlling; providing or implementing a configuration associated with a RD; monitoring a front-facing control link; boxes of FIG. 2; etc. Some of these techniques can be performed in cooperation with the interface 83.

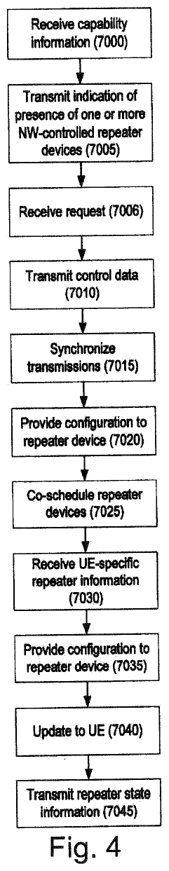

FIG. 4 is a flowchart of a method according to various examples. The method of FIG. 4 can be executed by a BS of a cell of the cellular NW. For instance, the method of FIG. 4 could be executed by the BS 91 of the cellular NW 91-1 of the example of FIG. 1. More specifically, the method of FIG. 4 could be executed by a processor upon loading and executing program code from a memory; cf. FIG. 3: processor 81 and memory 82.

At optional box 7000, the BS receives, from a UE, a capability information element. The capability information element is indicative of a capability of the UE to support communication between one or more NW-configured RDs and the cell and the UE on a control link that is provided by the one or more RDs.

The capability information may be received upon request by the BS. It would also be possible that the capability information is proactively provided by the UE. For instance, respective capability information could be provided upon a UE connecting to the cell.

At optional box 7005, the BS transmits a message that includes an information element. Information element is indicative of the presence of one or more NW-configured RDs and the cell.

For instance, the message could be broadcasted. For instance, the message could be a system information block.

In some scenarios, it would be possible that the indication of the presence of the one or more NW-controlled RDs at box 7005 is selectively transmitted upon receiving the capability information at box 7000, e.g., from at least one UE and the cell.

It would be possible that the indication of the presence of the one or more NW-controlled RDs is not indicative of the count of the RDs in the cell (i.e., does not reveal the actual number of RDs and takes the same form irrespective of the number, if there is at least one RD). Alternatively or additionally, the information element is not indicative of an identity of the one or more RDs. A 1-bit flag may be used.

At box 7006, the BS can receive a request for control data of an FF control link from a UE. For instance, the request could be associated with the indication of box 7005.

In other scenarios, the control data could be transmitted proactively. The control data could be transmitted in response to a coverage scenario of the UE or the RDs fulfilling a predefined criterion. Example predefined criteria would be a cell edge scenario.

At box 7010, it is possible to transmit control data of an FF control link provided by the one or more RDs and the cell to UEs in the cell.

The control data can be indicative of resources allocated to the control link.

For example, the resources can be time-frequency resources of a time-frequency resource grid of a carrier of the cell. Alternatively or additionally, the resources can be a modulation format of the FF control link.

The control data could be indicative of resources allocated to at least one of RRSs or detection beacons that are transmitted by the RDs of the FF control link.

The control data could be indicative of a type or configuration of RRSs that are transmitted by the one or more NW configured RDs on the control link.

The control data can include information associated with an identity of each one of the one or more NW-configured RDs. Such information may be used by the respective one of the RDs for communicating on the control link.

At box 7015, the BS may synchronize scheduling of a first transmission of data that is communicated between the BS and the UE—e.g., payload data, application data, control data, etc.; communication on PUSCH or PDSCH—and a second transmission on the control link. For instance, the UE may not be able to monitor the FF control link while engaging in the first transmission. By synchronizing the scheduling, such conflicts are avoided. For instance, time gaps may be defined during which the first transmission is paused, to thereby facilitate the monitoring of the control link by the UE during the time gaps.

At box 7020, the BS may provide a configuration to the one or more RDs to provide the control link in accordance with the control data. Respective aspects of the configuration have been discussed above in connection with TAB. 2.

It is possible, at box 7025, that the BS co-schedules multiple transmissions of multiple RDs on the control link. I.e., the control link can include shared resources that are accessed by multiple RDs. To avoid collisions, the BS may centrally schedule the multiple RDs on the control link. This can be aligned with the synchronization discussed above in connection with box 7015.

At box 7030, the BS can receive, from a UE in the cell, a report message. The report message is indicative of UE-specific repeater information of at least one RD of the one or more RDs and the cell. Examples of the information content of the report message have been discussed above in connection with TAB. 3.

As a general rule, it would be possible that the report message is received while the UE is not being served via the RD or while the UE is being served via the RD. It would also be possible that it is not known whether the UE is being served via the RD, i.e., while it is transparent whether the UE is being served via the RD. This means that even for a direct-coverage scenario, the UE may assist the BS in appropriate configuration of the RD, e.g., for other UEs that cannot be directly served by the BS.

Based on such UE-specific repeater information, it would be possible to adjust or redetermine the configuration of the respective RD (cf. TAB. 1). Accordingly, at box 7035, it would be possible to provide the configuration to the RD based on the UE-specific repeater information.

At box 7040, a respective reconfiguration message that is at least indicative of a part of the configuration can be transmitted to the UE. Updated control data of the FF control link may be transmitted to the UE. Incremental updates are possible.

At box 7045, the BS may transmit, to the UE, repeater state information. The repeater state information can be indicative of one or more operational characteristics of one or more RDs and the cell of the BS. For instance, the repeater state information could be indicative of a location of the RDs and/or a mobility level of the RDs. The repeater state information could be indicative of a radiofrequency operational parameter of the RDs used for providing the repeater mediated connectivity. Based on such repeater state information, the UE can further adjust its operation, e.g., to request being served via the RD, requesting the activation of the RD, etc.

Such information could be related to the physical location of the RD, and in case the RD is mobile, the BS can share information to the UE about the mobility information of the RD. This can be beneficial for a connected UE, e.g. to be aware of its relative position and relative movement with respect to the RD. Also, other information may be shared such as utilized output power, frequencies etc. This could further assist a connected UE in determining the available capacity and coverage of the RD.

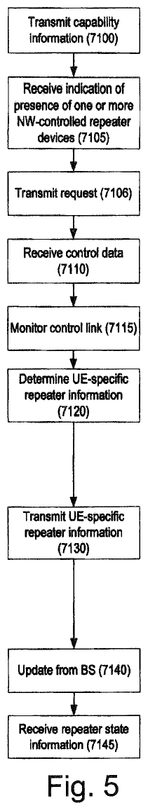

FIG. 5 is a flowchart of a method according to various examples. For instance, the flowchart of FIG. 5 may be executed by a UE such as the UE 92. The UE may be connected or connectable to a cellular NW. The UE may communicate with a BS of the cellular NW. For instance, a processor may load and execute program code from a memory to execute the method, cf. FIG. 3: processor 81 and memory 82.

At box 7100, the UE may transmit capability information. Box 7100 is interrelated with box 7000 of the method of FIG. 4. The UE can indicate its capability to monitor an FF control link of RDs or provide device-specific repeater information reporting (cf. TAB. 3).

At box 7105, the UE receives, from the BS, a message that includes an information element that is indicative of a presence of one or more NW-configured RDs in the cell of the BS.

The message may be broadcasted. The UE may receive the message via SIB-monitoring, e.g., while in idle mode.

Box 7105 is interrelated with box 7005 of the method of FIG. 4.

It would be possible that the UE then conditionally transmits, at box 7106, to the BS, a request for control data of an FF control link provided by the one or more RDs, based on the information element that is indicative of the presence of the one or more NW-configured RDs.

As a general rule, such request may be conditionally transmitted depending on one or more trigger criteria. Example trigger criteria include a channel quality measured by the UE, e.g., based on reference signals are transmitted by the BS or a mobility level of the UE.

Box 7106 is interrelated with box 7006.

The UE, at box 7110, can receive control data of the control link.

Box 7110 thus can correspond to box 7010.

At box 7115 the UE may monitor the control link in accordance with the control data.

Then, at box 7120, the UE can determine UE-specific repeater information based on the monitoring of the control link.

At box 7130, the UE can transmit a report message that includes the UE-specific repeater information.

Box 7130 thus corresponds to box 7030.

For instance, the UE at box 7115 may monitor for a detection beacon that is transmitted by the RD on the FF control link. Then, based on the detection beacon the UE can detect the RD. Accordingly, the device-specific repeater information can be indicative of an identity of the RD.

It would also be possible that the UE measures a channel quality based on RRSs that are repeatedly transmitted by the RD on the FF control link; the UE-specific repeater information can then be indicative of the channel quality.

The UE could determine whether the UE is being served via the RD. This could be based on a comparison of a first channel quality that is determined based on measuring a first channel characteristic based on RRSs with a second channel quality that is determined based on a second channel characteristic that is determined based on BS reference signals transmitted by the BS. Example channel characteristics would be a spatial filter, e.g., angle of arrival, etc. Another example channel characteristic would be signal strength or channel fading variation. The UE-specific information can then be indicative of whether the UE is being served via the RD.

It would be possible that the UE monitors the control link at box 7115 during time gaps that are defined by the BS. Here, transmission of data between the BS and the UE can be paused. The BS may inform the UE of these time gaps using conventional scheduling, e.g., on PDCCH.

At box 7140, the UE can receive a reconfiguration message from the BS that is indicative of at least a part of a configuration that has been updated by the BS for the NW-controlled RD.

Box 7140 corresponds to box 7040.

At box 7145, the UE can receive, from the BS, repeater state information. Box 7145 corresponds to box 7045.

Based on the repeater state information, the UE may decide whether it requests being served via the NW-controlled RD. The UE can decide whether it requests a change in the configuration of the NW-controlled RD.

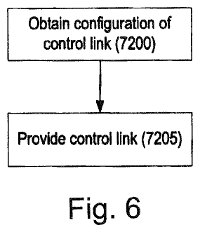

FIG. 6 is a flowchart of a method according to various examples. For instance, the flowchart of FIG. 6 may be executed by a NW-controlled RD such as the RD 95. The RD can be controlled by a BS of a cellular NW. For instance, the method of FIG. 6 can be executed by a processor upon loading and executing program code from a memory, cf. FIG. 3: processor 81 and memory 82.

At box 7200, the RD obtains a configuration from a BS. Aspects with respect to such configuration have been discussed above in connection with TAB. 1 and TAB. 2. Specifically, a configuration of an FF control link can be obtained.

At box 7205, the RD can then provide the FF control link in accordance with the configuration.

For instance, the configuration can include one or more transmission parameters of the control link. Examples have been discussed in connection with TAB. 2.

Summarizing, in connection with FIG. 4, FIG. 5, and FIG. 6 various functionality is associated with RDs have been disclosed. First, capability signaling from the UE to the NW pertaining to supporting an FF control link that is provided to the UEs by the RDs. Second, NW indication of presence or absence of RDs within a cell. Third, control data associated with the configuration of the FF control link. Fourth, UE reporting of UE-specific repeater information. Fifth, UE detection of NW-controlled RDs. All such aspects may be individually or jointly implemented.

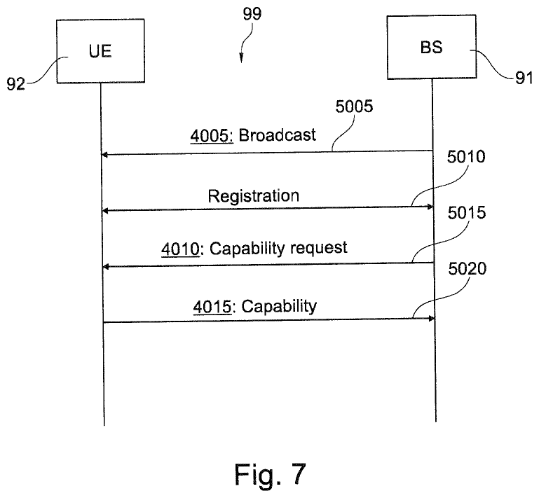

FIG. 7 is a signaling diagram of control signaling between the BS 91 and the UE 92. FIG. 7 illustrates aspects with respect an aspect of capability signaling from the UE to the NW; and NW indication of presence or absence of RDs within a cell. Both aspects are shown as being jointly implemented, but could also be implemented individually.

At 5005, the BS 91 transmits a broadcast message 4005 that includes an information element indicative of the presence of one or more RDs in the cell. This corresponds to box 7005 and box 7105 of the methods of FIG. 4 in FIG. 5, respectively.

At 5010, a registration procedure of the UE 92 at the BS 91 is executed. For instance, the UE 92 may transition from idle mode to the connected mode and set up a data connection. The registration procedure can include a random-access procedure.

At 5015, the BS 91 may then transmit a request message 4010, requesting a capability indication from the UE. The UE, at 5020 responds and transmits, to the BS, a message that includes a capability information element that is indicative of a capability of the UE to support communication between RDs and the UE on a respective control link 98. This corresponds to box 7000 of the method of FIG. 4 and box 7100 of the method of FIG. 5.

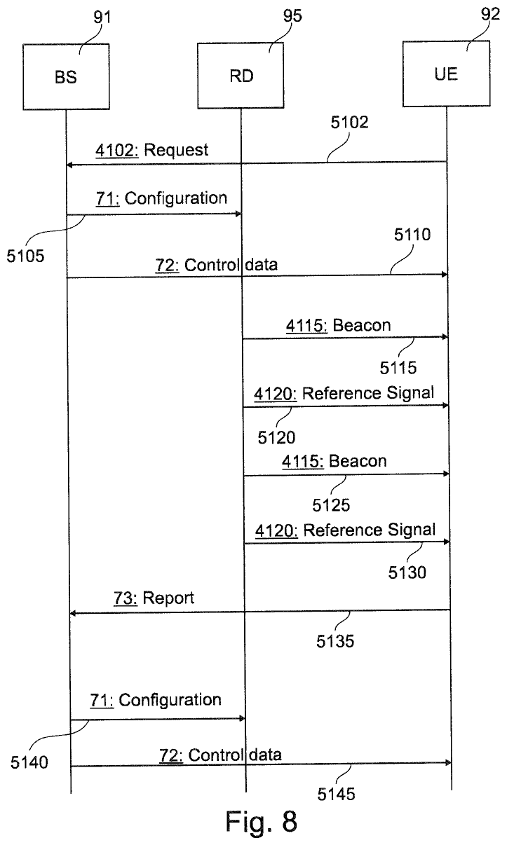

The signaling can then continue in accordance with the signaling illustrated in FIG. 8.

FIG. 8 is a signaling diagram of control signaling between the BS 91 and the UE 92 and the RD 95. FIG. 8 illustrates aspects of control data associated with the configuration of an FF control link 98; UE reporting of device-specific repeater information; and UE detection of an RD 95. These aspects are shown as being jointly implemented, but could also be implemented individually.

At 5102, the UE 92 transmits to the BS 91 a request 4102 for control data of the FF control link 98 by the RD 95. This corresponds to box 7006 and box 7106 of the methods of FIG. 4 in FIG. 5, respectively.

The request could be triggered by the information element indicative of the presence of one or more RDs, included in the broadcast message 4005 (cf. FIG. 7).

More generally, once the NW determines an own need or a wish from a UE to monitor or setup the FF control link 98, the BS 91 may inform the UE about additional information on how to receive smart repeater specific information. The BS 91 provides the control data 72 to the UE 92, at 5110.

The control data 72 can inform the UE about dedicated control signaling radio resources being utilized by the RD 95. By informing a UE about these resources (such as time and frequency resources, modulation formats utilized, signaling information block formats, and similar types of information needed or beneficial to detect signals), the UE 92 can detect signaling transmitted by the RD 95 on the FF control link 98. In some cases, the transmission of the control data 72 is triggered by the BS wanting to get UE-specific repeater information in a respective report message 73 to improve the usage of the RD 95. In some cases, the transmitting of the control data 72 is triggered by a UE which may determine its wish to potentially improve the radio link via getting repeater information from the BS, e.g., in response to a request 4102.

To accommodate the UE detection of the signals from the repeater, the NW may assign specific control signal monitoring slots (time gaps) in time, wherein the regular communication between the UE 92 and the BS 91 is not utilized, allowing the UE 92 to use such paused time slots to monitor the RD signaling. This has been explained in connection with box 7015 in FIG. 4.

Further, the NW may inform the UE about specific identification sequence, identification code or other ID to be detectable by the UE in order to specifically confirm a signaling being transmitted by one or more BS 91 controlled smart repeaters.

All such and further information may be included in the control data 72.

The BS 91 can also provide, at 5105, the configuration 71 compatible with the control data 72 to the RD 95. This can occur earlier, e.g., upon activation of the RD 95.

Once the NW has provided the control data 72 including information that may be utilized for detection of signaling of the RD 95, the UE 92 may use the information to conduct detection of any RDs. More generally, the UE 92 can monitor the control link 98. The UE may use the information provided by the NW and may detect one or more control links 98 from one or more NW-controlled RDs 95. This is illustrated in FIG. 8 where at 5115 and 5125 the RD 95 repeatedly transmits identification beacons 4115 on the control link 98.

The UE 92 can then, at 5135, transmit information about the detected RDs 95 such as identities of the RDs 95 and their serving signal strength to the BS 91 in a respective report message 73.

The RD 95 may also transmit RRSs 4120 at 5120 and 5130. For example, the BS 91 may request the RD 95 to transmit specific RRSs (pilot signals) in one or more directions or with a certain repetition pattern, on a certain bandwidth part or similar instructions. This can be indicated in the configuration 71. Such RRRs may e.g. include so-called demodulation reference signals which can be beneficial for improved channel estimation and thereby, e.g., improved demodulation performance of received signals by the UE 92. Such RRSs may e.g. be included in bursts.

Using the control data 72, the BS 91 can inform the UE 92 how to detect the RRSs. Such information may include time, frequency, modulation formats, coding formats and the like. This may be implemented with a new additional downlink control information (DCI) which adds additional information on how to decode this new reference signal.

The UE 92 being informed about these RRSs reports the channel conditions to the BS 91 in the report message 73. For instance, a respective report may be included on the 3GPP PUCCH where uplink control information (UCI) is added with a second/additional channel quality information is included. This channel quality information may include absolute values of how well the UE can decode data from the NW by using the combination of both the ordinary/legacy reference signals and the new additional RRSs. Alternatively, the new channel quality information may provide information related to detection specifically of the new added RRSs.

For example, the UE may correlate the detection characteristics of the RD information signaling—e.g., the RRSs or other signals—with other received channels (such as the ordinary downlink data and control channels—PDSCH, PDCCH, . . . ) to determine not only which RDs are available to detect by the UE, but also to inform the BS 91 on whether the UE 92 is connected to (i.e., served via) one of the RDs or not. Note that since the RD transmissions as such are supposed to be transparent to the UE 92, the UE 92 cannot typically use the detected information as such to determine whether it is receiving the data from the RD 95 or from the BS 91 directly. But with the radio characteristics (beams, signal strengths, channel fading variations, etc.), it is possible to determine whether the UE 92 receives both a specific signaling from an RD on the FF control link 98 as well as the ordinary transmissions from the same RD. The UE 92 can transmit the information to the BS 91 as well, to indicate the UE is connected via an RD 95.

The cellular NW 91-1 may use this information to improve the cell deployment, e.g. to take the UE detection information into account for transmitting activate/deactivate commands to the connected RDs within the cell, or to transmit power control commands to the RDs within the cell. A respective configuration 71 is provided at 5140. Updated control data 72 may be transmitted to the UE 92 at 5145 upon this reconfiguration.

Accordingly, the BS 91 may utilize feedback information it receives from one or more UEs to adjust characteristics of the RD 95 and to inform the UEs about this information as well, e.g., if the UE has indicated it is connected to a particular RD 95.

Once the BS 91 is aware of the UE being connected via a specific RD 95, the BS 91 may use device-specific repeater information provided by the UE 92 to the BS 91 to enhance the RD management. In other words, the BS 91 may use information provided by the UE to adjust the transmissions from the smart repeater.

The report message 73—when received while the UE 92 is being served via the RD 95—can be used in order to gain information in the NW on how to utilize the RD in a more efficient manner, i.e. to enhance the performance for one or more of the UEs being served via the RD 95.

Summarizing, above signaling methods have been disclosed that enable UEs to detect information of RDs, as well as to report such information. Methods have been disclosed which enable the BS to adjust its management of RDs based on the reported UE-specific repeater information.

UE capability indication signaling has been disclosed, indicative of the UE supporting detection of RDs by monitoring a respective control link and reporting of UE-specific repeater information. (A UE without this support would not know that the received signals are sent via a repeater).

The UE can request control data of the control link to indicate the interest from UE to receive information on how to monitor the control link to detect the UE-specific repeater information.

System information signaling has been disclosed, indicative of the presence of one or more BS-managed RDs within the cell.

The BS transmits control data of the FF control link. The control data is indicative of the resources required to monitor for the UE to detect repeater specific signaling.

Aspects of detection reporting by the UE have been disclosed. UE measurement reporting of the identity and signal strength of detected RRSs.

It has been disclosed how a UE can determine whether or not it is not only detecting RRSs but also is served by the BS via that particular RD.

Signaling to support the BS-control of RD has been disclosed; e.g., the BS can instruct the RD to transmit RRSs, e.g., in a burst transmission. The control data of the control link provided to the UE can instruct the UE how to detect and report the RRS bursts. The BS may then utilize RRS burst measurement reports to adjust the configuration and/or location of a smart repeater.

Accordingly, at least the following EXAMPLEs have been disclosed.

EXAMPLE 1.A method of operating a base station serving a cell of a cellular network, the method comprising:
transmitting, to a wireless communication device, control data of a control link provided by one or more network-configured repeater devices in the cell to wireless communication devices, the one or more network-configured repeater devices providing a repeater-mediated connectivity to wireless communication devices in the cell, the control link supporting the repeater-mediated connectivity.

EXAMPLE 2. The method of EXAMPLE 1,
wherein the control data is indicative of resources allocated to the control link.

EXAMPLE 3. The method of EXAMPLE 2,
wherein the resources are at least one of time-frequency resources of a time-frequency resource grid of a carrier of the cell or a modulation format of the control link.

EXAMPLE 4. The method of any one of the preceding EXAMPLEs,
wherein the control data is indicative of resources allocated to at least one of repeater reference signals or detection beacons transmitted by the one or more network-configured repeater devices on the control link.

EXAMPLE 5. The method of any one of the preceding EXAMPLEs,
wherein the control data is indicative of a type or configuration of repeater reference signals transmitted by the one or more network-configured repeater devices on the control link.

EXAMPLE 6. The method of any one of the preceding EXAMPLEs,
wherein the control data comprises information associated with an identity of each one of the one or more network-configured repeater devices and used by the respective one of the one or more network-configured repeater devices for communicating on the control link.

EXAMPLE 7. The method of any one of the preceding EXAMPLEs, further comprising:
synchronizing scheduling of a first transmission of data communicated between the base station and the wireless communication device and of a second transmission on the control link.

EXAMPLE 8. The method of EXAMPLE 7,
wherein said synchronizing comprises defining time gaps during which the first transmission is paused, to thereby facilitate monitoring of the control link by the wireless communication device during the time gaps.

EXAMPLE 9. The method of any one of the preceding EXAMPLEs, further comprising:
receiving, from a wireless communication device, a report message indicative of device-specific repeater information of at least one network-configured repeater device of the one or more network-configured repeater devices, to thereby facilitate providing a configuration to the at least one network-configured repeater device.

EXAMPLE 10. The method of EXAMPLE 9,
providing the configuration to the at least one network-configured repeater device based on the device-specific repeater information.

EXAMPLE 11. The method of EXAMPLE 9 or 10,
wherein the configuration comprises activating or deactivating or configuring a transmission of at least one type of repeater reference signals on the control link,
wherein said configuring of the transmission of the at least one type of repeater reference signals comprises at least one of setting a frequency hopping pattern, setting a frequency range, setting a timing pattern, or setting a spatial filter for the transmission of the at least one type of repeater reference signals.

EXAMPLE 12. The method of EXAMPLE 11,
wherein the at least one type of repeater reference signals corresponds to demodulation repeater reference signals.

EXAMPLE 13. The method of any one of EXAMPLEs 9 to 12
wherein the device-specific repeater information comprises a measurement report of a channel measurement performed by the wireless communication device based on repeater reference signals transmitted by the at least one network-configured repeater device.

EXAMPLE 14. The method of any one of EXAMPLEs 9 to 13,
wherein the device-specific repeater information is indicative of whether the wireless communication device is served via the network-configured repeater device.

EXAMPLE 15. The method of any one of EXAMPLEs 9 to 14,
wherein the device-specific repeater information is indicative of an identity of each one of the at least one network-configured repeater device.

EXAMPLE 16. The method of any one of the preceding EXAMPLEs, further comprising:
transmitting a message comprising an information element indicative of a presence of the one or more network-configured repeater devices in the cell.

EXAMPLE 17. The method of EXAMPLE 16,
wherein the message comprising the information element indicative of the presence of the one or more network-configured repeater devices in the cell is broadcasted.

EXAMPLE 18. A method of operating a wireless communication device connectable to a cellular network, the method comprising:
receiving control data of a control link provided by one or more network-configured repeater devices in a cell of the cellular network, the one or more network-configured repeater devices providing a repeater-mediated connectivity to wireless communication devices in the cell, the control link supporting the repeater-mediated connectivity.

EXAMPLE 19. The method of EXAMPLE 18, further comprising:
monitoring the control link based on the control data,
based on said monitoring of the control link, determining, for at least one network-configured repeater device of the one or more network-configured repeater devices, device-specific repeater information, and
transmitting, to a base station of the cellular network, a report message comprising the device-specific repeater information.

EXAMPLE 20. The method of EXAMPLE 19, further comprising:
based on said monitoring of the control link, detecting the at least one network-configured repeater device,
wherein the device-specific repeater information is indicative of an identity of the at least one network-configured repeater device,
wherein said detecting comprises monitoring for a detection beacon repeatedly transmitted by the at least one network-configured repeater device on the control link.

EXAMPLE 21. The method of EXAMPLE 19 or 20, further comprising:
based on said monitoring of the control link, measuring a channel quality based on repeater reference signals repeatedly transmitted by the at least one network-configured repeater device on the control link,
wherein the device-specific repeater information is indicative the channel quality.

EXAMPLE 22. The method of any one of EXAMPLEs 19 to 21, further comprising:
based on said monitoring of the control link, determining whether the wireless communication device is served via the at least one network-configured repeater device,
wherein the device-specific repeater information is indicative of whether the wireless communication device is served via the at least one network-controlled repeater device.

EXAMPLE 23. The method of EXAMPLE 22, further comprising:
based on said monitoring of the control link, measuring a first channel characteristic based on repeater reference signals repeatedly transmitted by the at network-configured least one repeater device on the control link,
measuring a second channel characteristic based on base-station reference signals repeatedly transmitted by a base station of the cellular network, and
based on a comparison of the first channel characteristic and the second channel characteristic, determining whether the wireless communication device is served via the at least one network-controlled repeater device.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

1. A method of operating a base station serving a cell of a cellular network, the method comprising:
transmitting, to a wireless communication device, control data of a control link provided by one or more network-configured repeater devices in the cell to wireless communication devices, the one or more network-configured repeater devices providing a repeater-mediated connectivity to wireless communication devices in the cell, the control link supporting the repeater-mediated connectivity.

2. The method of claim 1, wherein the control data is indicative of resources allocated to the control link.

3. The method of claim 2, wherein the resources are at least one of time-frequency resources of a time-frequency resource grid of a carrier of the cell or a modulation format of the control link.

4. The method of claim 1, wherein the control data is indicative of resources allocated to at least one of repeater reference signals or detection beacons transmitted by the one or more network-configured repeater devices on the control link.

5. The method of claim 1, wherein the control data is indicative of a type or configuration of repeater reference signals transmitted by the one or more network-configured repeater devices on the control link.

6. The method of claim 1, wherein the control data comprises information associated with an identity of each one of the one or more network-configured repeater devices and used by the respective one of the one or more network-configured repeater devices for communicating on the control link.

7. The method of claim 1, wherein the control data is transmitted upon a request by the wireless communication device for the control data.

8. The method of claim 7, wherein the request is associated with an information element that is indicative of the one or more network-configured repeater devices being present in the cell, the information element being transmitted by the base station.

9. The method of claim 1, wherein the control data is transmitted in response to a coverage scenario of the wireless communication device or the one or more network-configured repeater devices fulfilling a predefined criterion.

10. The method of claim 1, further comprising:
synchronizing scheduling of a first transmission of data communicated between the base station and the wireless communication device and of a second transmission on the control link.

11. The method of claim 10, wherein said synchronizing comprises defining time gaps during which the first transmission is paused, to thereby facilitate monitoring of the control link by the wireless communication device during the time gaps.

12. The method of claim 1, further comprising:
providing a configuration to the one or more network-configured repeater devices to provide the control link in accordance with the control data.

13. The method of claim 1, wherein the control link is shared between multiple network-configured repeater devices,
wherein the method further comprises:
co-scheduling transmissions of the multiple network-configured repeater devices on the control link.

14. The method of claim 1, further comprising:
receiving, from a wireless communication device, a report message indicative of device-specific repeater information of at least one network-configured repeater device of the one or more network-configured repeater devices, to thereby facilitate providing a configuration to the at least one network-configured repeater device.

15. The method of claim 14, further comprising:
providing the configuration to the at least one network-configured repeater device based on the device-specific repeater information.

16. The method of claim 14, wherein the configuration comprises at least one of switching off the at least one network-configured repeater device, adjusting a transmit power of the at least one network-configured repeater device, adjusting one or more spatial filters of the at least one network-configured repeater device, or adjusting a location of the at least one network-configured repeater device.

17. The method of claim 14,
wherein the configuration comprises activating or deactivating or configuring a transmission of at least one type of repeater reference signals on the control link,
wherein said configuring of the transmission of the at least one type of repeater reference signals comprises at least one of setting a frequency hopping pattern, setting a frequency range, setting a timing pattern, or setting a spatial filter for the transmission of the at least one type of repeater reference signals.

18. The method of claim 17, wherein the at least one type of repeater reference signals corresponds to demodulation repeater reference signals.

19-33. (canceled)

34. A method of operating a wireless communication device connectable to a cellular network, the method comprising:
receiving control data of a control link provided by one or more network-configured repeater devices in a cell of the cellular network, the one or more network-configured repeater devices providing a repeater-mediated connectivity to wireless communication devices in the cell, the control link supporting the repeater-mediated connectivity.

35-49. (canceled)

50. A method of operating a network-configured repeater device in a cell of a cellular network served by a base station of the cellular network, the method comprising:
obtaining, from the base station, a configuration to provide a control link, and
providing, in accordance with the configuration, the control link to one or
more wireless communication devices in the cell to support a repeater-mediated connectivity between the one or more wireless communication devices and the base station.

51-58. (canceled)
